(19) United States
(12) Patent Application Publication
(10) Pub. No.: US 2012/0327950 A1
(43) Pub. Date: Dec. 27, 2012

(54) Method for Transmitting Data Packets

(75) Inventors: Franz-Josef GÖTZ, Heideck (DE); Günter STEINDL, Poppenricht (DE)

(73) Assignee: Siemens Aktiengesellschaft, Muenchen (DE)

(21) Appl. No.: 13/528,611

(22) Filed: Jun. 20, 2012

(30) Foreign Application Priority Data
Jun. 22, 2011 (EP) EP11170979

(51) Int. Cl. H04L 12/56

(52) U.S. Cl. 370/412

(57) ABSTRACT

Method for transmitting data packets in an Ethernet automation network, wherein the method comprises receiving a first data packet having a first priority by a transmitter, starting a transmit operation to send the first data packet from the transmitter to a receiver, receiving a second data packet having a second priority at an instant in time by the transmitter, where the second priority is higher than the first priority, and where the second data packet is to be transmitted to the receiver. The method further comprises aborting the transmit operation of the first data packet within one of the data frames of the first data packet which is located in the transmit operation at the time of the reception of the second data packet, and thereupon transmitting the second data packet from the transmitter to the receiver.

### BACKGROUND OF THE INVENTION

1. Field of the Invention

The invention relates to a method for transmitting data packets in an Ethernet automation network and, more particularly, to a method for transmitting data packets having different priorities.

2. Description of the Related Art

Methods for transmitting data packets are known from the prior art. For example, DE 10 2008 039 580 A1 discloses a method for transmitting data packets in a communication network, where first data packets having a low priority are transmitted between a transmitter and a receiver of the communication network and where second data packets having a high priority compared to the first data packets are transmitted with preference between the transmitter and the receiver. In the case of a second data packet that is to be transmitted from the transmitter to the receiver, a check is performed to determine whether a first data packet is being transmitted at the present time. If the result of the check to determine whether a first data packet is presently being transferred is positive, the transmission of the first data packet is aborted or interrupted and thereupon the second data packet is transmitted. Following the transmission of the second data packet, the transmission of the non-transmitted first data packet is repeated or the transmission of the remainder of the incompletely transmitted first data packet is initiated. In parallel with a transmit operation, each first data packet is stored in a buffer memory and is not deleted from the buffer memory until after the first data packet has been transmitted in its entirety to the receiver.

EP 1 734 700 A1 describes a method for transmitting data in a data network using an Ethernet data transfer link. Here, a method for transmitting data is described in which the transmission of a first data telegram to which a first priority is assigned is interrupted to transmit a second data telegram to which a second priority is assigned.

WO2009/089850 A1 describes a method for operating a communication network, i.e., a local data network based on Ethernet technology. In order to reduce latency times during the transmission of time-sensitive data frames, a first data frame is subdivided into a plurality of data fragments by a switch, at least one of the data fragments of the first data frame is transmitted via a transmit port of the switch to a receive port of another switch, the transmission of the data fragments of the first data frame is interrupted by the switch, and at least one second data frame having a higher priority than the first data frame is transmitted via the transmit port of the switch to the receive port of the other switch, the transmission of the data fragments of the first data frame via the transmit port of the switch to the receive port of the other switch is subsequently continued and the first data frame is reconstituted by the other switch from the received data fragments. WO2009/089850 A1 additionally relates to a switch and to a communication network.

### SUMMARY OF THE INVENTION

It is an object of the present invention to provide an improved method for transmitting data packets in an Ethernet automation network, an improved transmitter for an Ethernet automation system, an improved computer program product and an improved automation system.

These and other objects and advantages are achieved in accordance with the invention by a method for transmitting data packets in an Ethernet automation network in which data packets consist of a plurality of data frames. A minimum size of the data frames amounts to less than 64 bytes. The minimum size of data frames in conventional Ethernet networks is equal to 64 bytes, because above this minimum frame size the collision detection function comes into operation in the Ethernet. Collision detection in the Ethernet operates in accordance with the Carrier Sense Multiple Access/Collision Detection (CSMA/CD) method. A minimum frame size of 64 bytes is necessary for this detection so that a transmitter can detect the collision of the sent frame with another frame and therefore has information to the effect that the sent frame has not been received correctly by the receiver.

In an embodiment of the method in accordance with the invention, a first data packet having a first priority is received by a transmitter. The transmitter can comprise a device, such as a network node, a router, a switch or a bridge. A transmit operation to send the first data packet from the transmitter to a receiver is thereupon initiated. During the transmit operation a second data packet having a second priority is received. Here, the second priority is higher than the first priority. Furthermore, the second data packet is to be transmitted to the receiver. It should be noted that more priorities than simply two priorities are also possible. The different priority levels indicate the importance of the data packet within the network. For example, realtime data has a relatively high priority or even the highest priority, while user data, such as internet data, has a relatively low priority or even the lowest priority. By comparing the priorities, the transmitter obtains information indicating how important a packet is for the mode of operation of the automation network. Realtime data, for example, should be forwarded as expeditiously as possible, since any delay may disrupt the automation process that is being executed by the automation network.

An automation network can comprise, e.g., an industrial automation network. Such industrial automation networks can be embodied, configured and/or provided, e.g., for open- and/or closed-loop control of industrial facilities (e.g., production plants or conveyor systems), machinery and/or equipment. Automation networks or industrial automation networks can have in particular realtime communication protocols (e.g., Profinet, Profibus or Real-Time Ethernet) for the purpose of communicating at least between the components involved in the open- and/or closed-loop control functions (e.g., between the control units and the plants and/or machines to be controlled). The secure transmission of data via storage media is likewise covered.

In addition to a realtime communication protocol, however, at least one further communication protocol (which, e.g., does not need to be realtime-capable) can also be provided in the automation network or industrial automation network, e.g., for monitoring, configuring, reprogramming and/or reparameterizing one or more control units in the automation network.

An automation network can include, e.g., hardwired communication components and/or wireless communication components. An automation network can also include at least one automation device.

An automation device can be, for example, a computer, PC and/or controller having control functions or control capabilities. In particular, an automation device can be, for example, an industrial automation device which can be embodied, configured and/or provided, e.g., specifically for open- and/or closed-loop control of industrial facilities. Such automation devices or industrial automation devices can in particular be realtime-capable, i.e., support open- and/or closed-loop control in real time. Toward that end, the automation device or industrial automation device can include e.g., a realtime operating system and/or support, at least inter alia, a realtime-capable communication protocol for communication purposes (e.g., Profinet, Profibus or Real-Time Ethernet).

An automation network comprises a plurality of sensors and actuators. The actuators and sensors are controlled by at least one control device. The actuators, the sensors and the at least one control device exchange data with one another. An automation protocol is used for the data exchange. The at least one control device controls the actuators, the sensors and the data exchange such that an automatic manufacturing process is executed in which, e.g., a product is manufactured.

An industrial automation device can be, e.g., a programmable logic controller, a module or part of a programmable logic controller, a programmable logic controller integrated in a computer or PC, as well as corresponding field devices, sensors and/or actuators, input and/or output devices or the like for connecting to a programmable logic controller or can comprise such devices.

Within the meaning of the present invention, an automation protocol is understood to denote any type of protocol that is provided, suitable and/or configured for communicating with automation devices in accordance with the presently disclosed embodiments. Such automation protocols can be, for example, the Profibus protocol (e.g., conforming to International Electrotechnical Commission (IEC) 61158/EN50170), a Profibus-DP protocol, a Profibus-PA protocol, a Profinet protocol, a Profinet-IO protocol, a protocol conforming to AS-Interface, a protocol conforming to IO-Link, a KNX protocol, a protocol conforming to a multipoint interface (MPI), a protocol for a point-to-point (PtP) link, a protocol conforming to the S7 communication specifications (which is provided and configured, for example, to support communication by programmable logic controllers of the company Siemens) or also an Industrial Ethernet protocol or Real-Time Ethernet protocol or, as the case may be, further specific protocols for communication with automation devices. Any combinations of the aforementioned protocols can also be provided as an automation protocol within the meaning of the present description.

Thus, if such a second data packet having a higher priority than the first data packet is received, the transmitter aborts the transmit operation of the first data packet within one of the data frames of the first data packet. The transmit operation is terminated at the instant in time at which the second data packet is received. In other words, the transmission of the data frame currently engaged in the transmit operation at the time of the reception of the second data packet is aborted. The second data packet is thereupon transmitted from the transmitter to the receiver.

The premature termination of the transmit operation within a data frame has the advantage that the higher-prioritized data is sent more quickly by the transmitter. In conventional systems, in contrast, a data frame is always transmitted right up to the end. Given a minimum size of the data frame of 64 bytes, as stipulated in the Ethernet, this results in a delay of 5 microseconds at a transfer rate of 100 Mbps, assuming the transmit operation of the data frame had only just started when the second data packet is received. Thus, for example, if the second data packet includes realtime data, the realtime data would be forwarded by the transmitter with a 5 microsecond delay. This delay is multiplied in each transmitter of the automation network. There is accordingly a total delay of 5 microsecond per network node, which can lead to a situation where the realtime data is overly delayed and errors occur in the automation network.

Shortening the minimum size of the data frames to less than 64 bytes means that the delay in sending the second data packet is reduced. If, for example, a data frame consists of just (or only) one (1) byte, the delay becomes reduced to 80 ns at a data transfer rate of 100 Mbps. The minimum size of the data frames can be reduced down to 1 byte. In order to avoid generating alignment errors, this 1 byte threshold must not be undershot.

In the event that the transmit operation of the first data packet is aborted within the data frame when the minimum size of the data frame has not yet been reached, the delay in the transmission of the second data packet is reduced to 40 ns at a transfer rate of 100 Mbps. This is because in this case only the last nibble still has to be sent. A nibble is half of one byte, i.e., 4 bits. In this instance, it is not necessary to transmit an entire byte, because an alignment error will not have any major repercussions. The aborted data frame is discarded at the receiver end anyway. Here, the result alignment error from the premature termination of the data frame without transmission of the last complete byte is inconsequential. Subsequently, when the second data packet has been transmitted, the aborted data frame must be retransmitted. If a part of the aborted data frame has already been received by the receiver, it is discarded in the receiver.

The last nibble must be transmitted in its entirety, because for example, Reduced Media Independent Interfaces (RMII) operate with nibbles. Transmitting less than 1 nibble, i.e., 4 bits, is not possible here.

Reducing the minimum size of the data frames to less than 64 bytes is advantageous because by this measure it is less often necessary to abort the transmission of the first data packet within a frame. The smaller the frame size, the less frequently the transmit operation must be aborted to transmit the second data packet. The greater the minimum size of the data frames, the more often the transmit operation of the first data packet will be aborted within one of the data frames of the first data packet, as a result of which the overall transmission time of the first data packet is subject to a considerable delay, because the interrupted data frame has constantly to be retransmitted. This means that data packets having a low priority would be transmitted extremely slowly through the automation network because their data transfer would be repeatedly interrupted by data packets having a second priority.

In accordance with embodiments of the invention, each data frame of the first data packet is buffered during the transmit operation. In the event that the transmit operation is aborted, the data frame whose transmission was prematurely terminated is re-transferred once to the buffer. This happens after the second data packet has been transmitted.

Buffering the data frames ensures that if the transmit operation is interrupted the data frame whose transmission has been interrupted will not be lost. Such a data frame will not be received correctly by the receiver. It must therefore be retransmitted to the receiver.

In other to embodiments of the invention, the transmit operation of the first data packet and the transmission of the second data packet take place over one transmission path from the transmitter to the receiver. The transmission path is used exclusively for data transfers from the transmitter to the receiver using the full-duplex method. In other words, data packets can be exchanged simultaneously between the transmitter and the receiver in both directions without collisions occurring between the data packets. With this feature, collisions between data packets transmitted in opposite directions over the same transmission path are avoided. Accordingly, collisions are also avoided when the minimum size of the data frames is less than 64 bytes.

In accordance with the disclosed embodiments of the invention, the transmission of the first data packet is aborted after transmission of one nibble. A nibble consists of 4 bits. Alternatively, the transmission of the first data packet can be aborted after transmission of a complete byte. This can be the case, for example, with Media Independent Interfaces (MII), where the smallest transmissible unit is one byte.

In accordance with other embodiments of the invention, the transmitter forwards a data frame of the data frames of the first and of the second data packet immediately after a first part of said data frame has been received. This can also be referred to as “cut-through switching”. By this measure, the data packets are forwarded faster, because no time is wasted in waiting until the data packet has been completely received by the transmitter before sending to the receiver.

In accordance with other embodiments of the invention, each of the data frames of the first and of the second data packet includes a destination address. The destination address specifies by which network interface of the transmitter the respective data frame is transmitted to the receiver. In other words, the transmit port of the transmitter is specified by the destination address. Only the receiver is connected to the transmit port, which can also be referred to as the network interface. Fast forwarding of the data packets is therefore guaranteed, because simply reading out the destination address directly defines the network interface through which the respective data frame is to be transmitted to the receiver.

In according with other embodiments of the invention, the second data packet includes realtime data of the automation network. The realtime data of the automation network must be forwarded as quickly as possible because it is essential for the correct execution of the automation process within the automation network. In particular, an excessive delay to the realtime data may cause the automation process to stall or to continue to execute only with errors. For this reason, it is advantageous that the second data packet having the higher priority is sent as quickly as possible by the transmitter to the receiver.

It is also an object to provide a transmitter for an Ethernet automation network for transmitting data packets. The data packets consist of a plurality of data frames. A minimum size of the data frames amounts to less than 64 bytes. The transmitter comprises a receiver for receiving a first data packet having a first priority. This can be a network interface, for example. In addition, the transmitter includes a starter for starting a transmit operation to send the first data packet to a receiver. The transmit operation can be started by a processor, for example. The first data packet can, for example, be sent to the receiver via a further network interface.

The transmitter also includes receiver for receiving a second data packet having a second priority. This can be received, for example, via the same network interface as the first data packet or via a different network interface. The second priority is higher than the first priority of the first data packet. The second data packet is likewise to be transmitted to the receiver. This can be specified, for example, by a destination address that is included in the data packet. The destination address can be read out by the processor, for example.

The transmitter additionally comprises an aborter for aborting the transmit operation of the first data packet within one of the data frames of the first data packet. The transmit operation is aborted at the data frame that is currently engaged in the transmit operation at the time of the reception of the second data packet. The transmit operation of the first data packet is aborted when the second data packet having the second priority is received. The transmitter also includes a transmitter for transmitting the second data packet to the receiver. This can be effected, for example, through the same network interface as the transmit operation of the first data packet.

It is also an object to provide a computer program product comprising instructions which can be executed by a transmitter and which upon being executed cause the transmitter to perform a method in accordance with the disclosed embodiments of the invention.

It is also an object to provide an automation network comprising at least one transmitter in accordance with the disclosed embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiment variants of the invention are explained below with reference to the figures, in which:

FIG. 1 shows a schematic block diagram of a data packet consisting of a plurality of data frames;

FIG. 2 shows a schematic block diagram of a transmitter in accordance with an embodiment of the invention; and

FIG. 3 shows a flowchart of a method in accordance with an embodiment of the invention.

### DETAILED DESCRIPTION OF THE PREFERRED EMBODIMENTS

Elements of the following figures are labeled with the same reference signs if the function of the element is identical.

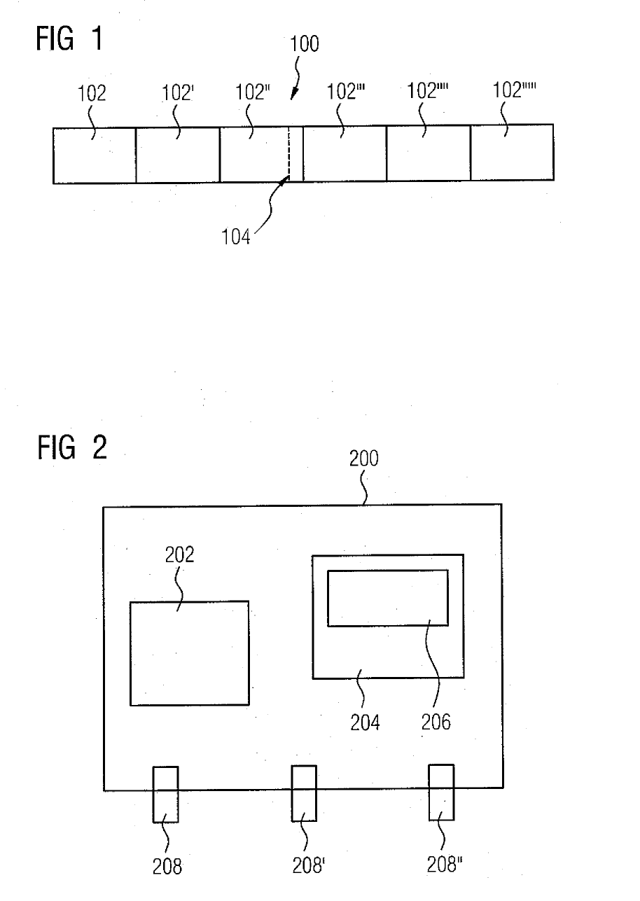

FIG. 1 is a schematic block diagram of a data packet 100. The data packet 100 consists of a plurality of frames 102-102″″′m. Each data frame 102 has a minimum size of less than 64 bytes. During the forwarding of the data packet 100 by a transmitter, such as a network node, a router, a switch or a bridge, the transmit operation of the data packet can be aborted within one of the data frames 102-102″″′. It is shown in FIG. 1, for example, that the transmission of the data frame 102″ is aborted at the point 104. A premature termination of the transmit operation of the data frame 102″ at the point 104 can be initiated, for example, when a different data packet (not shown in FIG. 1) having a higher priority than the data packet 100 shown here is to be sent by the transmitter currently sending the data frame 102″. This can be the case, for example, when the data packet 100 includes user data, such as Internet data, and the other data packet not shown in FIG. 1 includes important realtime data that is essential for the automation process of the automation network. If further data packets are now to be forwarded to the same receiver, the transmission of the data frame 102″ is aborted without the data frame 102″ being transmitted to the receiver in its entirety. The higher-prioritized data packet (not shown) containing the realtime data can therefore be forwarded with the greatest possible speed to the receiver. Following transmission of the higher-prioritized data packet, the aborted data frame 102″ is retransmitted, because it was not received correctly by the receiver and because it was not transmitted in its entirety.

Reducing the minimum size of the data frames to less than 64 bytes is furthermore advantageous, because by this measure it is not necessary to abort the transmission of a data frame as frequently as in the case of data frames having a higher minimum size. Accordingly, data assigned a lower priority is also transmitted reliably at an acceptable transfer rate. With a greater minimum size of the data frames 102, the transmissions of the lower priority data frames 102 would be aborted frequently because a higher-prioritized data packet has to be transmitted. Here, the forwarding of low priority data would be subject to significant delay.

FIG. 2 is a block diagram of a transmitter 200 comprising a processor 202, a data memory 204 and program instructions 206. The processor 202 is configured to execute the program instructions 206. The transmitter 200 also includes network interfaces 208-208″. The transmitter 200 is connected to other components of the automation network via the network interfaces 208-208″. For example, the transmitter 200 can be connected to one receiver via the network interface 208 and by the network interfaces 208′ and 208″ to other transmitters from which the transmitter 200 receives data in turn. In other words, the transmitter 200 is in this case configured to output data packets received through one of the network interfaces 208′ or 208″ to the receiver through the network interface 208.

During operation, a first data packet having a first priority is received through one of the network interfaces 208′ or 208″. The processor 202 thereupon reads the destination address of the first data packet and starts a transmit operation to send the first data packet to the receiver through the network interface 208. During the transmit operation, a second data packet having a second priority is received through one of the network interfaces 208′ or 208″. The second priority is higher than the first priority. The processor 202 also reads out the destination address of the second data packet in this case. The destination address coincides with the destination address of the first data packet. In other words, therefore, the second data packet is likewise to be transmitted to the receiver. The priorities are also read out in each case by the processor. By comparing the first priority with the second priority, the processor 202 possesses information to the effect that the forwarding of the second data packet is more important for the automation network than the transmit operation of the first data packet. The transmit operation of the first data packet is therefore aborted within one of the data frames of the first data packet. The transmission is aborted at the data frame that is currently engaged in the transmit operation at the time the second data packet is received. The second data packet is therefore sent with all possible speed to the receiver. This reduces the delay time in the case of high-priority data, such as realtime data. After the transmit operation of the first data packet is aborted, the second data packet is transmitted to the receiver through the network interface 208. Once the transmission of the second data packet has been completed, the transmit operation of the first data packet can be resumed. Toward that end, the aborted data frame is retransmitted, because the data frame previously failed to be received correctly by the receiver. The first data packet including the aborted data frame can be stored, for example, in the data memory 204 or on a different data storage medium. Either the entire data packet can be stored or else just a part thereof. For example, a data frame of the first data packet can be deleted in each case when the data frame of the first data packet has been transmitted in its entirety. Accordingly, only data frames of the first data packet that have not yet been transmitted in their entirety to the receiver are still contained in the data memory.

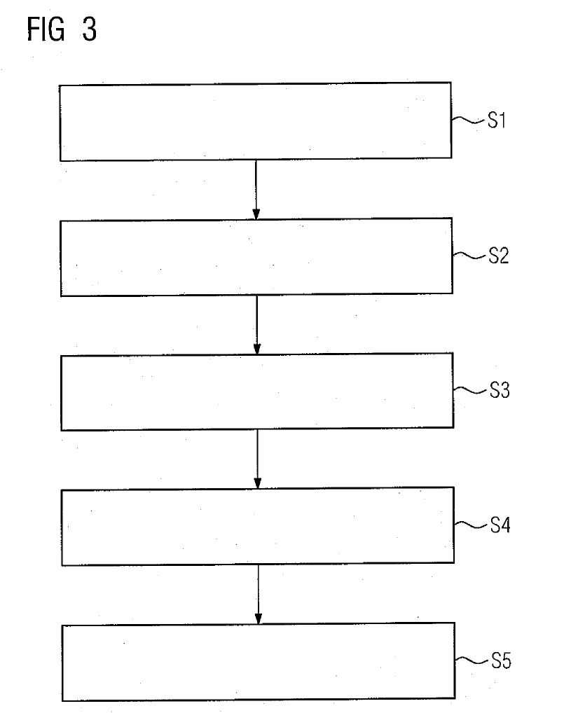

FIG. 3 is a flowchart of a method in accordance with an embodiment of the invention. In a first step S1, the first data packet having the first priority is received by the transmitter. Thereafter, in step S2, the transmit operation to send the first data packet from the transmitter to the receiver is started. The transmit operation continues to proceed during step S3. In step S3, the second data packet having the second priority is received by the transmitter at a time during which the transmit operation of the first data packet is still running. In this case, the second priority is higher than the first priority and the second data packet is likewise to be transmitted to the same receiver as the first data packet.

In step S4, the transmit operation of the first data packet is thereupon aborted within one of the data frames of the first data packet. The transmission of that data frame which is currently engaged in the transmit operation at the time of the reception of the second data packet is aborted. The transmit operation is consequently aborted as quickly as possible. No time is spent waiting until a data frame has been transmitted in its entirety. In step S5, the second data packet is thereupon transmitted from the transmitter to the receiver.

The transmit operation of the first data packet can be continued when the transmission of the second data packet has been completed. Here, the aborted data frame is retransmitted because the aborted data frame previously failed to be received correctly by the receiver. For this purpose, the first data packet is buffered in the transmitter during the transmission operation of the second data packet. The entire first data packet can be buffered, for example, or just that part of the first data packet which has not yet been transmitted in its entirety to the receiver.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for transmitting data packets in an Ethernet automation network, the data packets consisting of a plurality of data frames, where a minimum size of the data frames being less than 64 bytes, the method comprising:
receiving, by a transmitter, a first data packet having a first priority;
starting a transmit operation to send the first data packet from the transmitter to a receiver;
receiving, by the transmitter, a second data packet having a second priority at an instant in time, the second priority being higher than the first priority, and the second data packet is to be transmitted to the receiver;
aborting the transmit operation of the first data packet within a data frame of the first data packet which is currently engaged in the transmit operation at a time of reception of the second data packet; and
transmitting the second data packet from the transmitter to the receiver;
wherein each data frame of the first data packet is buffered in a buffer during the transmit operation; and
wherein, after the aborting the transmit operation of the first data packet, the data frame whose transmission is aborted is retransmitted from the buffer after the second data packet has been transmitted.

2. The method as claimed in claim 1, wherein the transmit operation of the first data packet and the transmission of the second data packet occur over one transmission path from the transmitter to the receiver, and wherein the transmission path is used exclusively for data transfers from the transmitter to the receiver.

3. The method as claimed in claim 1, wherein the transmit operation of the first data packet is aborted after transmission of one nibble or one byte.

4. The method as claimed in claim 1, wherein the transmitter forwards a data frame of the data frames of the first and second data packets immediately after a first part of the data frame has been received.

5. The method as claimed in claim 1, wherein each of the data frames of the first and second data packets includes a destination address, and wherein the destination address specifies through which network interface of the transmitter a respective data frame is transmitted to the receiver.

6. The method as claimed in claim 1, wherein the second data packet includes realtime data of the automation network.

7. A transmitter for an Ethernet automation network for transmitting data packets consisting of a plurality of data frames, a minimum size of the data frames being less than 64 bytes, the transmitter comprising:
a first interface for receiving a first data packet having a first priority;
a processor configured for starting a transmit operation of the first data packet to a receiver;
a second interface for receiving a second data packet having a second priority which is higher than a first priority, wherein the second data packet is to be transmitted to the receiver;
the processor further configured for aborting the transmit operation of the first data packet within one data frame of the first data packet located in the transmit operation at a time of reception of the second data packet;
the processor further configured for transmitting the second data packet to the receiver; and
a buffer configured to store each data frame of the first data packet during the transmit operation;
wherein, after the aborting the transmit operation of the first data packet, the data frame whose transmission was aborted is retransmitted from the buffer after, the second data packet has been transmitted.

8. The transmitter of claim 7, wherein the starter comprises data memory including program instructions.

9. A computer program product stored on a non-transitory computer-readable storage medium encoded with a computer program executable on a processor of a transmitter to transmit data packets in an Ethernet automation network, the computer program comprising instructions causing the transmitter to perform the following:
receiving, by the transmitter, a first data packet having a first priority;
starting a transmit operation to send the first data packet from the transmitter to a receiver;
receiving, by the transmitter, a second data packet having a second priority at an instant in time, the second priority being higher than the first priority, and the second data packet is to be transmitted to the receiver;
aborting the transmit operation of the first data packet within a data frame of the first data packet which is currently engaged in the transmit operation at a time of reception of the second data packet; and
transmitting the second data packet from the transmitter to the receiver;
wherein each data frame of the first data packet is buffered in a buffer during the transmit operation; and
wherein, after the aborting the transmit operation of the first data packet, the data frame whose transmission is aborted is retransmitted from the buffer after the second data packet has been transmitted.

10. An automation network comprising at least one transmitter as claimed in claim 7.
